(19) United States
(12) Patent Application Publication
(10) Pub. No.: US 2026/0187105 A1
(43) Pub. Date: Jul. 2, 2026

(54) DYNAMIC GRAPH AUGMENTATION FOR IMPROVED CONTEXTUAL RETRIEVAL

(71) Applicants: Constructor Technology AG, Schaffhausen (CH); Constructor Education and Research Genossenschaft, Schaffhausen (CH)

(72) Inventors: Sergey ULASEN, Singapore (SG); Vasyl SHANDYBA, Dnipro (UA); Andrey ADASHCHIK, Istanbul (TR); Serg BELL, Singapore (SG); Stanislav PROTASOV, Singapore (SG); Nikolay DOBROVOLSKIY, Alanya (TR); Laurent DEDENIS, Geneve (CH)

(21) Appl. No.: 19/005,680

(22) Filed: Dec. 30, 2024

(51) Int. Cl. G06F 16/332; G06F 16/3329

(52) U.S. Cl. CPC G06F 16/3326; G06F 16/33295

(57) ABSTRACT

Disclosed herein are systems and method for a dynamic knowledge graph (KG) augmentation of an LLM. The method includes obtaining a LLM chat history between a user and the LLM enhanced with a KG database. The LLM chat history includes user queries, relevant knowledge data retrieved from the KG database, and LLM answers for each user query. The LLM answers are based at least in part on relevant knowledge data retrieved from the KG database. The method also includes applying a KG update MLM agent trained to: analyze the LLM chat history, KG database and the graph schema and to identify: (i) a missing knowledge data from the KG database, and/or (ii) a missing relationship between knowledge data nodes in the KG database. The method further includes after identifying missing knowledge data and/or the missing relationship, updating the KG database with new knowledge data and/or new relationship between nodes.

### FIELD OF TECHNOLOGY

The present disclosure relates to the field of large language models (LLMs), and, more specifically, to systems and methods for improving retrieval-augmented generation (RAG) of graph databases using LLM queries.

### BACKGROUND

Large Language Models (LLMs) are advanced artificial intelligence systems designed to understand and generate human-like text. Built on transformer architectures, LLMs leverage billions or trillions of parameters to process language in a context-aware and nuanced manner. These models are trained on vast and diverse datasets, enabling them to perform a wide range of tasks such as text generation, summarization, translation, and conversational artificial intelligence (AI). Despite their power, LLMs can sometimes “hallucinate” or produce plausible but incorrect information due to their reliance on statistical patterns rather than real-time knowledge.

To address the limitations of LLMs, Retrieval-Augmented Generation (RAG) integrates information retrieval systems with generative language models. RAG uses a retriever to search external databases or knowledge sources for relevant context (e.g., documents used by the LM to generate responses/answers), which is then provided to the LLM as additional input. This approach enhances the factual accuracy and relevance of generated responses by grounding them in up-to-date or domain-specific information. RAG is especially valuable in open-domain question answering, customer support, and any scenario requiring dynamic integration of external knowledge with natural language understanding.

GraphRAG (Graph-based Retrieval-Augmented Generation) is an advanced approach in the field of natural language processing (NLP) that combines RAG techniques with graph structures to enhance information retrieval and response generation. By leveraging graphs, GraphRAG enables richer contextual relationships, better organization of knowledge, and improved accuracy in generated responses. GraphRAG uses knowledge graphs as its foundational data structure. The graph's entities and relationships provide the retrieval layer in GraphRAG, offering precise and interconnected information that augments the generative language model. This integration allows GraphRAG to produce more accurate, explainable, and contextually rich outputs compared to standard RAG systems that rely solely on text-based retrieval.

### SUMMARY

To address the shortcomings of LLMS, the present disclosure describes analyzing a LLM chat history to determine a user's satisfaction with the LLM responses and then dynamically updating a graph database to improve search results in the graph database. Some of the technical improvements of the present disclosure are enhancing LLMs by combining the deep, unstructured generation capabilities of LLMs with the precision and structure of knowledge graphs to produce more accurate, relevant, and context-aware responses. In this way, the present disclosure improves the performance of LLM responses by at least speed and accuracy. Yet another technical improvement of the present disclosure is dynamically detecting and updating types of relationships in the current graph schema based on the LLM chat history.

In one exemplary aspect, a method for dynamic knowledge graph (KG) augmentation of an LLM is described, the method comprising: obtaining a LLM chat history between a user and the LLM enhanced with a KG database, wherein the LLM chat history comprises a plurality of user queries, relevant knowledge data retrieved from the KG database, and LLM answers for each user query, wherein the LLM answers are based at least in part on relevant knowledge data retrieved from the KG database, wherein the knowledge data is organized in a graph schema 124 of nodes and relationships between the nodes; applying a KG update MLM agent trained to: analyze the LLM chat history, KG database and the graph schema and to identify: (i) a missing knowledge data from the KG database, and/or (ii) a missing relationship between knowledge data nodes in the KG database; and, after identifying missing knowledge data and/or the missing relationship, updating the KG database with new knowledge data and/or new relationship between nodes.

In one aspect, the analyzing, by the KG update MLM agent, the LLM chat history comprises: analyzing feedback of the user in one or more follow-up queries to the LLM answers to identify a new knowledge data in the feedback that is missing from the KG database and/or a missing relationship between knowledge data nodes in the KG database, wherein the feedback comprises one or more of: asking the LLM a follow-up question to explain a certain topic or concept of the LLM answer, asking the LLM to include a certain new topic or a concept in LLM answer that were missing in the preceding LLM answers, and asking the LLM to explain how two or more concepts or topics related to each other.

In one aspect, analyzing, by the KG update MLM agent, the chat history comprises: determining a level of satisfaction with the LLM answers from the user using a NLP-based sentiment analysis that identifies feelings of positivity or negativity in the user queries, wherein the level of satisfaction is based on one or more of: a number of times the user repeated substantially similar query using different words; if the user indicated directly or indirectly that the LLM answer is incorrect, incomplete or unclear; if the user indicated directly or indirectly that the LLM answer is complete, correct or clear; and if the user indicated directly or indirectly that a new knowledge data made the LLM answer complete, correct or clear; and determining if a new relevant knowledge data used in the LLM answer increased the user's level of satisfaction with the LLM answer, but said new relevant knowledge data does not have a relationship with other relevant knowledge data used in the LLM answer.

In one aspect, identifying the missing relationships in the KG database further comprises: detecting a new type of relationships between relevant knowledge data using information from at least one of the chat history, dataset, or a graph schema.

In one aspect, updating the KG database further comprises: updating the relationships the graph schema of nodes and relationships between the nodes without node change operations to improve graph updating operation speed.

In one aspect, the method further comprises: extracting nodes of a first type of node in the graph schema of nodes and relationships between the nodes and a second type of node in the graph schema of nodes and relationships between the nodes; building a probability matrix of new edges existing between the extracted nodes with the first type of node and the extracted nodes with the second type of node; and generating the new relationships between the graph schema of nodes and relationships between the nodes based on the probability matrix.

In one aspect, the KG update MLM agent corresponds to a LLM.

According to one aspect of the disclosure, a system is provided for dynamically updating relationships within a LLM, the system comprising at least one memory; and at least one hardware processor coupled with the at least one memory and configured, individually or in combination, to: obtain a LLM chat history between a user and the LLM enhanced with a KG database, wherein the LLM chat history comprises a plurality of user queries, relevant knowledge data retrieved from the KG database, and LLM answers for each user query, wherein the LLM answers are based at least in part on relevant knowledge data retrieved from the KG database, wherein the knowledge data is organized in a graph schema of nodes and relationships between the nodes; apply a KG update MLM agent trained to: analyze the LLM chat history, KG database and the graph schema and to identify: (i) a missing knowledge data from the KG database, and/or (ii) a missing relationship between knowledge data nodes in the KG database; and, after identifying missing knowledge data and/or the missing relationship, update the KG database with new knowledge data and/or new relationship between nodes.

In one exemplary aspect, a non-transitory computer-readable medium is provided storing a set of instructions thereon for dynamically updating relationships within a LLM, wherein the set of instructions comprises instructions for: obtaining a LLM chat history between a user and the LLM enhanced with a KG database, wherein the LLM chat history comprises a plurality of user queries, relevant knowledge data retrieved from the KG database, and LLM answers for each user query, wherein the LLM answers are based at least in part on relevant knowledge data retrieved from the KG database, wherein the knowledge data is organized in a graph schema of nodes and relationships between the nodes; applying a KG update MLM agent trained to: analyze the LLM chat history, KG database and the graph schema and to identify: (i) a missing knowledge data from the KG database, and/or (ii) a missing relationship between knowledge data nodes in the KG database; and, after identifying missing knowledge data and/or the missing relationship, updating the KG database with new knowledge data and/or new relationship between nodes.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for dynamically updating relationships within a large language model (LLM) according to aspects of the present disclosure.

FIG. 2 is a block diagram of a pipeline for a dynamic graph augmentation for improved contextual retrieval according to aspects of the present disclosure.

FIG. 3 is a block diagram of a method for dynamically updating relationships within a large language model according to aspects of the present disclosure.

FIG. 4 is a flow diagram of a method for dynamically updating relationships within a large language model according to aspects of the present disclosure.

FIG. 5 is a flow diagram of a method for dynamically updating relationships within a large language model according to aspects of the present disclosure.

FIG. 6 presents an example of a general-purpose computer system on which aspects of the present disclosure can be implemented.

Like reference numbers and designations in the various drawings indicate like elements.

### DETAILED DESCRIPTION

Exemplary aspects are described herein in the context of a system, method, and computer program product for a machine-learning (ML)-based process for dynamically updating relationships within a LLM. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

The present disclosure describes various aspects of ML-based process for updating relationships within a LLM to improve search results in a graph database based on an LLM chat history. A first aspect involves analyzing the LLM chat history to determine whether a user is satisfied with the responses from the LLM. A second aspect involves searching a graph database to identify missing data knowledge or missing relationships between knowledge data notes in the KG database. A third aspect involves dynamically updating the graph database by changing relationships between data entities to improve search results in the graph database.

Retrieval-Augmented Generation (RAG) is the process of optimizing the output of a LLM, so it references an authoritative knowledge base outside of its training data sources before generating a response. In other words, RAG enhances the performance and relevance of LLMs by integrating external knowledge sources into their response generation process. By leveraging graph databases as the retrieval mechanism, this approach taps into structured, highly connected datasets (documents, articles, etc.), which are particularly adept at representing complex relationships. Graph databases excel at organizing data in nodes and edges, making them ideal for scenarios requiring rapid traversal of intricate relationships—something that can significantly optimize LLM outputs in domains like knowledge management, recommendation systems, and contextual queries.

In a RAG system utilizing a graph database, when an LLM encounters a prompt, it queries the graph database to retrieve relevant nodes and their associated relationships. The retrieved data, enriched by the graph's inherent semantic structure, provides the model with precise and contextually rich inputs. This reduces the reliance on the model's internal memory, which may lack recent or domain-specific information, and ensures that the responses are grounded in an up-to-date and interconnected knowledge base. For instance, querying a graph database about a scientific topic allows the LLM to pull highly relevant articles, related research fields, or citations, ensuring a nuanced response.

Another significant advantage is the speed and efficiency of graph databases in handling queries. Traditional relational databases might struggle with queries that involve multi-hop relationships or associative patterns. Graph databases, in contrast, are optimized for these operations. Their ability to quickly traverse relationships enables the RAG framework to perform near-real-time retrievals, ensuring the LLM generates responses that are not only relevant but also timely. This is particularly beneficial in dynamic fields such as finance, healthcare, or technology, where relationships between entities constantly evolve. The combination of RAG and graph databases ensures better explainability of LLM responses. By tracing the nodes and edges used during retrieval, users can understand how the model derived its conclusions, thereby increasing trust in its outputs. This integration represents a powerful step toward creating LLM systems that are not only intelligent but also transparent and reliable.

However, integrating a graph database into a RAG framework adds a layer of architectural and operational complexity. Setting up, maintaining, and optimizing graph databases for efficient querying require expertise in graph data modeling and database management. Poorly designed schemas or overly complex graph structures can result in inefficient traversal and slow retrieval times, undermining the benefits of the integration.

In addition, graph databases rely heavily on the quality and completeness of the data they store. If the underlying data is incomplete, outdated, or biased, the LLM will generate responses based on inaccurate or skewed information. This can lead to erroneous conclusions or reinforcement of existing biases, particularly in fields where the data is sourced from subjective or controversial domains. Determining what constitutes “relevant” data in a graph database is not always straightforward. Query mechanisms may retrieve information that is loosely connected or tangentially related to the input query. This can lead to responses that, while technically accurate, may lack focus or specificity, reducing the overall quality of the LLM's output.

Turning now to the figures, example aspects are depicted with reference to one or more components described herein, where components in dashed lines may be optional.

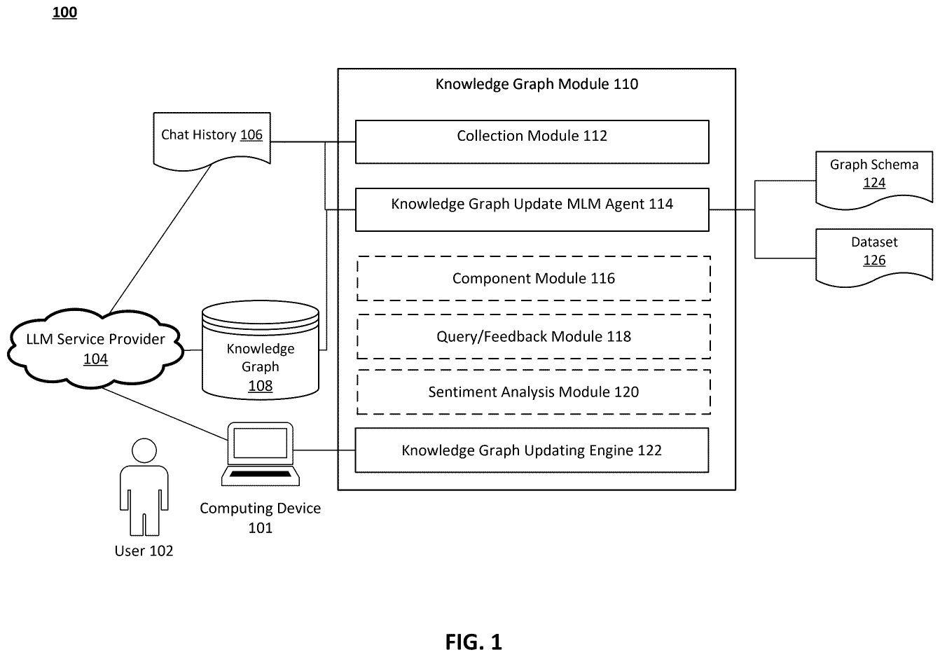

FIG. 1 is a block diagram illustrating a system 100 for dynamically updating relationships within a LLM. The system 100 may be used to determine whether a user 102 is satisfied with responses from the LLM based on analyzing LLM chat history 106 and providing dynamic graph augmentation for improved contextual retrieval for LLM models using a knowledge graph module 110. Specifically, the knowledge graph module 110 for updating iteratively is configured to detect possible types of relationships based on the LLM chat history 106 (e.g., questions, relevant context, answers, etc.) such that when the knowledge graph module 110 detects new types of relationships it updates relationships in the current graph schema.

In some aspects, the knowledge graph module 110 is configured to update only relationships in the knowledge graph 108 database without node changes operations that improve graph updating operation speed. In addition, the knowledge graph module 110 may make a decision about updating the set of types of existing relationship in the knowledge graph 108 database based on analyzing the LLM chat history 106. In particular, the knowledge graph module 110 may take into account direct or indirect user feedback and response level satisfaction from the user 102. The computing device 101 may communicate with the knowledge graph module 110.

The system 100 includes a computing device 101, a LLM service provider 104, a knowledge graph 108, LLM chat history 106, a knowledge graph module 110, a graph schema 124, and a dataset 126. The LLM service provider 104 offers access to large-scale AI models capable of natural language understanding, generation, and related functionalities. The LLM service provider 104 enables the system 100 to integrate LLM models into applications, tools, and/or workflows without requiring extensive expertise in AI model deployment by providing application programming interfaces (APIs) to integrate LLM capabilities into applications without needing on-premise infrastructure.

The knowledge graph 108 is a structured representation of information that captures relationships between entities in a way that machines can understand, process, and utilize. The knowledge graph 108 uses nodes to represent entities and edges to represent the relationships between them. Key features of a knowledge graph 108 include entities and relationships, semantic context, schema and ontologies, data integration, and query capabilities. The nodes in the knowledge graph 108 represent real-world things such as “Albert Einstein” or “E=mc².” The edges define how entities are related such as “Albert Einstein->formulated->E=mc². Accordingly, knowledge graphs 108 encode meaning and context, making it easier for systems to infer new knowledge and answer complex queries. For example, knowledge graphs 108 are often built using schemas or ontologies, which define the types of entities and relationships, ensuring consistency. In addition, knowledge graphs 108 may integrate diverse data sources, connecting structured and unstructured data into a cohesive framework. Knowledge graphs 108 may be queried using languages for enabling retrieval of specific information or relationships. The benefit of knowledge graphs 108 is adding depth to raw data by modeling how entities are interrelated, capability to handle large and complex datasets, adaptability as new data and relationships emerge, and bridging gaps between siloed data systems.

The LLM chat history 106 refers to the record of previous interactions, messages, or exchanges that occur between the user 102 and a LLM from the LLM service provider 104 during a conversation. The LLM chat history 106 is maintained to provide context, improve continuity, and enable coherent and context-aware responses from the LLM. By remembering prior exchanges with the user 102, the LLM can refer back to earlier parts of the conversation, ensuring responses remain relevant and consistent. For example, if the user 102 asks “Who discovered penicillin?” and follows up with “What year was that”?, the LLM can infer that “that” refers to penicillin. LLM chat history 106 improves user experience by maintaining a flow of conversation, which makes interactions feel more natural and human-like. In addition, the LLM adapts its responses based on the ongoing context provided by the LLM chat history 106, allowing for more tailored and nuanced answers by responding to feedback from the user 102.

As shown in FIG. 1, the system 100 may also include a computing device 101 that may communicate with the knowledge graph module 110. The computing device 101 allows for the user 102 to control and configure the system 100 and view results from the LLM service provider 104. Computing device 101 may execute a plurality of modules in the knowledge graph module 110 that tougher make up an identifying, analysis, and retrieval system. In some aspects, the knowledge graph module 110 may correspond to a computing device 101 or cloud network that is configured to execute a plurality of modules that together make up the knowledge graph module 110. The knowledge graph module 110 may obtain one or more LLM chat history 106 in order to obtain user 102 feedback on responses generated by the LLM service provider 104.

In some aspects, the knowledge graph module 110 may include a collection module 112, a knowledge graph (KG) update MLM agent 114, an optional component module 116, an optional query/feedback module 118, an optional sentiment analysis module 120, and a KG updating engine 122.

The interaction between a LLM from the LLM service provider 104, LLM chat history 106, and knowledge graph 108 enables accurate, context-aware, and informed responses from the LLM. For example, the LLM chat history 106 provides the LLM from the LLM service provider 104 with prior interactions during the session, ensuring that the conversation remains relevant and coherent. When the LLM encounters a query requiring factual precision or structured data, it interacts with the knowledge graph 108. The knowledge graph 108 serves as an external database of facts, offering accurate and structured information about entities and their relationships. The LLM then uses the LLM chat history 106 to refine its knowledge graph queries, ensuring that they align with the user's 102 ongoing context. In other words, the combined use of the LLM chat history 106 and the knowledge graph 108 prevents redundant or irrelevant information. After retrieving information from the knowledge graph 108, the LLM translates structured data into natural, conversational language, maintaining coherence with the LLM chat history 106. For multi-turn conversations, the LLM continuously adapts its knowledge graph queries based on both the LLM chat history 106 and user clarifications/feedback. The LLM can also extract new information from the conversation or external sources and suggest updates to the knowledge graph 108. By combining the contextual understanding of LLM chat history 106, the factual precision of knowledge graphs 108, and the conversational fluency of LLMs, this integrated system delivers highly intelligent and user-friendly AI experiences.

The computing device 101 may execute the collection module 112 to obtain LLM chat history 106 between the user 102 and the LLM from the LLM service provider 104 enhanced with the knowledge graph 108 database. The LLM chat history 106 may include at least user queries, relevant knowledge data retrieved from the knowledge graph 108 database and LLM responses (e.g., answers) for each query by the user 102. The LLM responses may be based at least in part on relevant knowledge data retrieved from the knowledge graph 108 database. The knowledge data is organized in a graph schema of nodes and relationships between the nodes. As explained above, knowledge data is structured using a graph schema. The graph schema is a blueprint or structure that defines how data is organized in the knowledge graph 108 database by outlining the types of nodes, edges (e.g., relationships), properties, and their constraints that define rules for the graph (e.g., ensuring unique property values or enforcing the presence of required properties). Nodes represent objects or entities (e.g., people, places, or concepts). For example, each node can belong to one or more labels or types (e.g., person, city). Nodes also have properties, which are key-value pairs that store data (e.g., a person node may have properties such as name, age, and address). The edges represent the connection between the nodes. For example, edges are directed (e.g., have a start and end node) and can have types (e.g., friends_with, lives_in). The properties refer to key-value pairs associated with nodes and edges to store additional information. This graph-based organization enables efficient storage, retrieval, and analysis of complex relationships, allowing systems to model real-world connections in a machine-readable and highly interconnected format.

The computing device may also execute the KG update MLM agent 114 prepared to analyze the LLM chat history 106, knowledge graph 108 database, and the graph schema 124 and to identify: (1) missing knowledge data from the knowledge graph 108 database, and/or missing relationship between knowledge data nodes in the knowledge graph 108 database. In some aspects, the KG update MLM agent 114 may also detect a new type of relationships between relevant knowledge data using information from at least one of the LLM chat history 106, dataset 126, or a graph schema 124. In some aspects, the KG update MLM agent 114 corresponds to LLM.

Preparing the KG update MLM agent 114 involves several steps including combining natural language processing (NLP), graph analysis, and knowledge base management techniques. First, the problem scope should be defined. As an example, the inputs may correspond to the LLM chat history 106 (e.g., LLM interactions that may reference or imply knowledge updates), knowledge graph 108 database (e.g., existing knowledge graph with nodes, edges, and properties), and graph schema 124 (e.g., blueprint for what entities and relationships are valid in the knowledge graph 108) and the outputs may correspond to identification of missing data (e.g., nodes or properties) and/or identification of missing relationships (e.g., edges) in the knowledge graph 108. Next, the data should be prepared by annotating the LLM chat history 106, enhancing the knowledge graph 108, and defining graph schema 124 rules. For example, a “ground truth” enhanced version of the knowledge graph should be created and missing nodes, relationships, or properties should be annotated based on the graph schema 124.

The training workflow for the KG update MLM agent 114 involves an optional preprocessing step, fine-tuning the MLM on a task-specific dataset where input is the LLM chat history 106, knowledge graph 108 snapshot, graph schema 124 and the output is missing nodes and/or missing edges. In some examples, a graph neural network (GNN) may be prepared to predict missing edges based on the graph structure and schema constraints. Following on the previous example, the MLM outputs (e.g., semantic inference) and GNN predictions (e.g., graph consistency) may be combined to propose updates to the knowledge graph 108.

At a high level, the inference for the KG update MLM agent 114 may include using the KG update MLM agent 114 to extract entities and relationships from the LLM chat history 106, checking if the extracted entities or relationships exist in the knowledge graph 108, using the GNN to suggest plausible relationships or validate new entities against the graph schema 124, and proposing knowledge graph updates with a confidence score for evaluation. In addition, feedback on the accepted and rejected updates may be used to further fine-tune the KG update MLM agent 114.

The computing device may also execute the optional component module 116 to extract nodes of a first type of node in the graph schema of nodes and relationships between the nodes and a second type of node in the graph schema of nodes and relationships between the nodes. The optional component module 116 may also be executed to build a probability matrix of new edges existing between the extracted nodes with the first type of node and the extracted nodes with the second type of node and generate the new relationships between the graph schema of nodes and relationships between the nodes based on the probability matrix.

The computing device may also execute the optional query/feedback module 118 to analyze feedback of the user 102 in follow-up queries to the LLM response to identify a new knowledge data in the feedback that is missing from the knowledge graph 108 database and/or a missing relationship between the nodes in the knowledge graph 108 database. In some aspects, the feedback may include at least one of: asking the LLM a follow-up question to explain a certain topic or concept of the LLM answer, asking the LLM to include a certain new topic or a concept in LLM answer that were missing in the preceding LLM answers, and asking the LLM to explain how two or more concepts or topics related to each other.

The computing device may also execute the optional sentiment analysis module 120 to determine a level of satisfaction with the LLM answers from the user using a NLP-based sentiment analysis that identifies feelings of positivity or negativity in the user queries and determine if a new relevant knowledge data used in the LLM answer increased the user's level of satisfaction with the LLM answer, but said new relevant knowledge data does not have a relationship with other relevant knowledge data used in the LLM answer. In some aspects, the the level of satisfaction is based on one or more of: a number of times the user repeated substantially similar query using different words; if the user indicated directly or indirectly that the LLM answer is incorrect, incomplete or unclear; if the user indicated directly or indirectly that the LLM answer is complete, correct or clear; and if the user indicated directly or indirectly that a new knowledge data made the LLM answer complete, correct or clear.

The computing device may execute the KG updating engine 122 to update the knowledge graph 108 database with new knowledge data and/or new relationships between the knowledge data nodes. In some aspects, the KG updating engine 122 may also update the relationships the graph schema of nodes and relationships between the nodes without node change operations to improve graph updating operation speed.

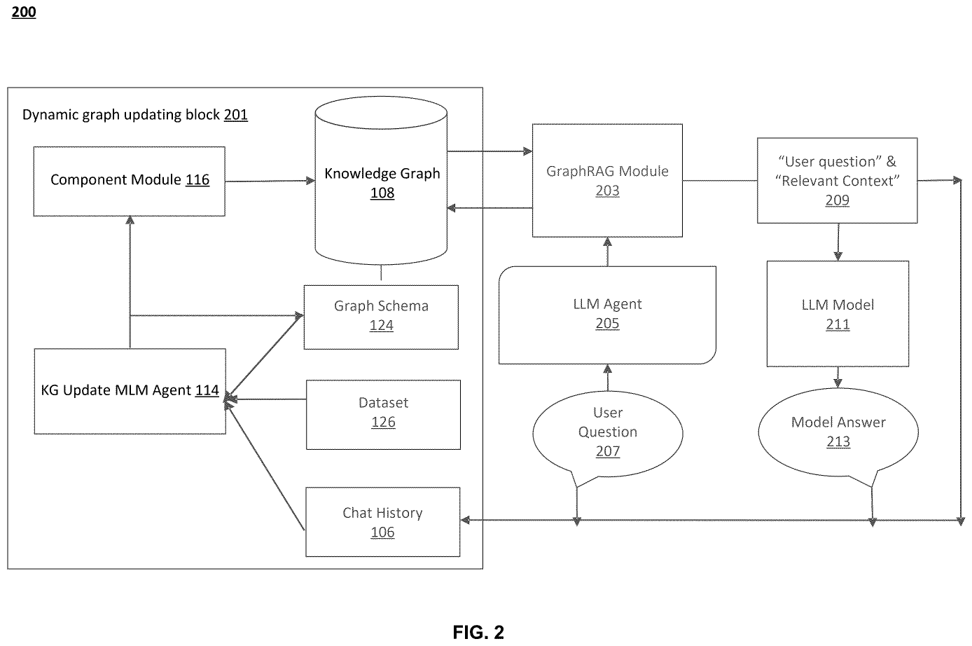

FIG. 2 is a block diagram of a pipeline for a dynamic graph augmentation for improved contextual retrieval according to aspects of the present disclosure. In various implementations, the method 200 is performed by a device with one or more processors and non-transitory memory that performs intent prediction. In some implementations, the method 200 is performed by processing logic, including hardware, firmware, software, or a combination thereof. In some implementations, the method 200 is performed by a processor executing code stored in a non-transitory computer-readable medium (e.g., a memory). The method 200 describes dynamically updating relationships within a LLM.

A user (e.g., user 102 from FIG. 1) may enter a user question 207 (e.g., query) for input as a query into a LLM 211. In addition, the user question 207 is stored in the LLM chat history 106 to provide context, improve continuity, enable coherent and context-aware responses from the LLM. The LLM agent 205 may also transform the user question 207 into a graph database language query. Since the GraphRAG module 203 relies on graph databases to manage and query structured knowledge graphs, the GraphRAG module 203 can utilize a variety of graph database languages for tasks such as querying, updating, and maintaining the graph data. As a non-limiting example, the graph database languages may include Cypher (Neo4j) for querying entities and relationships in the knowledge graph 108 to retrieve relevant content, Gremlin (Apache TinkerPop) for traversing the knowledge graph and retrieving communities or connected entities, SPARQL (RDF and Semantic Graphs) for working with RDF-based knowledge graphs and querying semantic data, Graph Query Language (GQL), ArangoDB Query Language (AQG) for facilitating integration of graph and non-graph data sources, Logical Query Language (Datalog), or Property Graph Query Language (PGQL). The choice of graph database language may depend on the database type (e.g., property graph v. RDF graph), use case (e.g., semantic reasoning v. traversal efficiency), and/or performance needs (e.g., large-scale graph analytics v. standards-based querying). By leveraging these graph database languages, the GraphRAG module 203 can efficiently query and manage the structured knowledge graphs 108 to retrieve context relevant 209 to the user question 207.

As an illustrative example, the GraphRAG module 203 may analyze the user question 207 transformed from the LLM agent 205 to identify key entities and relationships. For example, if the user question 207 is “What is the impact of deforestation on biodiversity?”, it recognizes terms like “deforestation” and “biodiversity” and their implied connection. The user question 207 is then contextualized with the knowledge graph 108 to pinpoint related nodes (entities) and edges (relationships) that represent the concepts being queried. The system then uses the knowledge graph 108 (e.g., a structured representation of entities and their interconnections) to locate clusters or “communities” that align with the user question 207. These communications represent thematic groupings, allowing the system to retrieve a focused set of information. The GraphRAG module 203 applies graph algorithms to detect relevant communities in the knowledge graph 108. In some aspects, the GraphRAG module 203 may summarize these communities using LLMs 211 to condense the information into digestible snippets.

The retrieved content may be used to enhance the original user question 207 in order to provide the LLM 211 with structured and focused supplementary information. This augmented query helps the LLM 211 generate a more precise and comprehensive response 213. In some aspects, the GraphRAG module 203 may iterate between the retrieved context and the LLM's generation process refining the response by exploring additional related nodes or summarizing further. With the user question and relevant context 209 (e.g., documents used by the LLM to generate answers), the GraphRAG module 203 leverages its generative capabilities to synthesize an answer that integrates structured knowledge (e.g., from the knowledge graph 108) with unstructured insights (e.g., from the LLM 211).

By using the knowledge graph 108, the GraphRAG module 203 can disambiguate terms in the user question 207 and provide precise answers 213. In addition, the GraphRAG module 203 retrieves and integrates only the most relevant information, reducing noise and improving the quality of the response. Accordingly, the GraphRAG module 203 may connect and summarize information from multiple graph nodes to ensure comprehensive answers 213.

The method 200 also includes improving contextual retrieval based on dynamic graphic augmentation. The dynamic graph updating block 201 includes at least the KG update MLM agent 114, the optional component module 116, the knowledge graph 108, graph schema 124, dataset 126, and LLM chat history 106.

In particular, a KG update MLM agent 114 may be prepared to analyze the LLM chat history, knowledge graph 108 database and the graph schema 124 and to identify: (i) a missing knowledge data from the knowledge graph 108 database, and/or (ii) a missing relationship between the nodes in the knowledge graph 108 database. For example, the KG update MLM agent 114 is configured to iteratively detect possible types of relationships based on the LLM chat history 106 (e.g., questions, relevant context, answers), summary/snapshot of dataset 126, and current graph schema 124. For example when the KG update MLM agent 114 detects new types of relationships, it launches a process of updating relationships in the current graph schema. In some aspects, the KG update MLM agent 114 only updates relationships in the graph without node change operations to improve the operation speed of updating the graph. In some aspects, the relationships updating proposal has a predefined schema: “(node: NodeType_1)-[:new relation type]->(node: NodeType_2)”

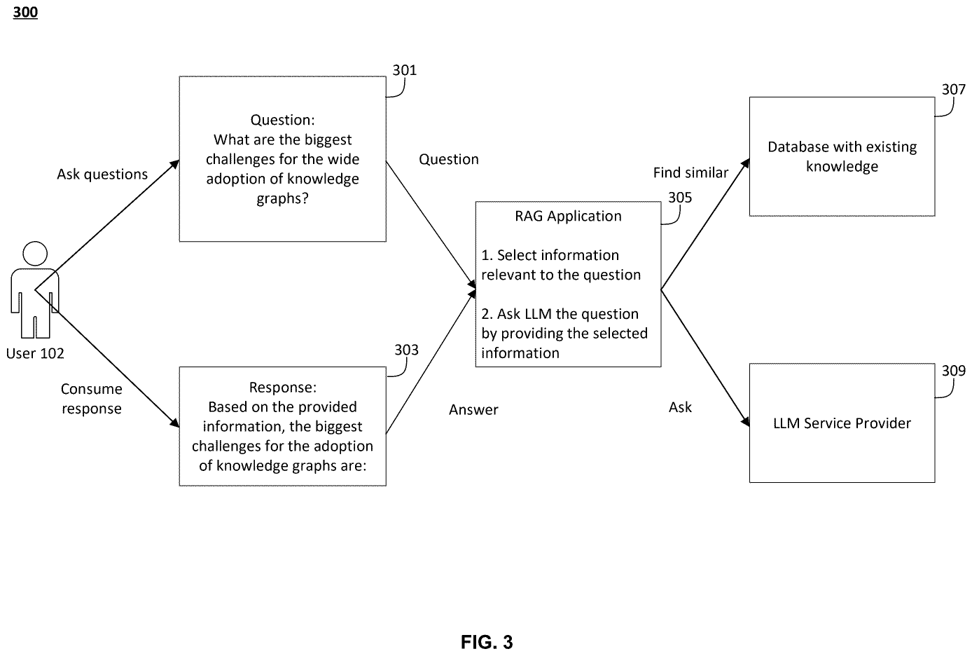

FIG. 3 is a block diagram of an example for dynamically updating relationships within a large language model according to aspects of the present disclosure.

As shown in example 300, the user 102 may ask a question 301 such as “what are the biggest challenges for the wide adoption of knowledge graphs?” to enter into a LLM. The response 303 from the LLM may answer “Based on the provided information, the biggest challenges for the adoption of knowledge graphs are . . . ” Here, the RAG application 305 may be configured to: (1) select information relevant to the question 301 and ask the LLM the question by providing the selected information. Next, the RAG application 305 may also find similar or relevant information for the question by querying a database with existing knowledge 307 and ask the LLM service provider 309.

As an example, a user 102 may ask a question about quantum physics. The LLM may generate several responses, but the responses do not discuss Schrodinger's equation, which is important to quantum physics and expected by the user. The user 102 then asks the LM why it did not discuss Schrodinger's equation. The example 300 may search a graph database for quantum physics domain and connects documents about Schrodinger's equation to the quantum physics domain and updates the knowledge graph database. As another example, if the original connection existed between Shrodinger's equation and quantum physics existed, but was “weak”, then the example 300 may update the connection by making it “stronger.”

In this way, the RAG application 305 enhances LLMs by combining the deep, unstructured generation capabilities of LLMS with the precision and structure of knowledge graphs, resulting in more accurate, relevant, and context-aware responses.

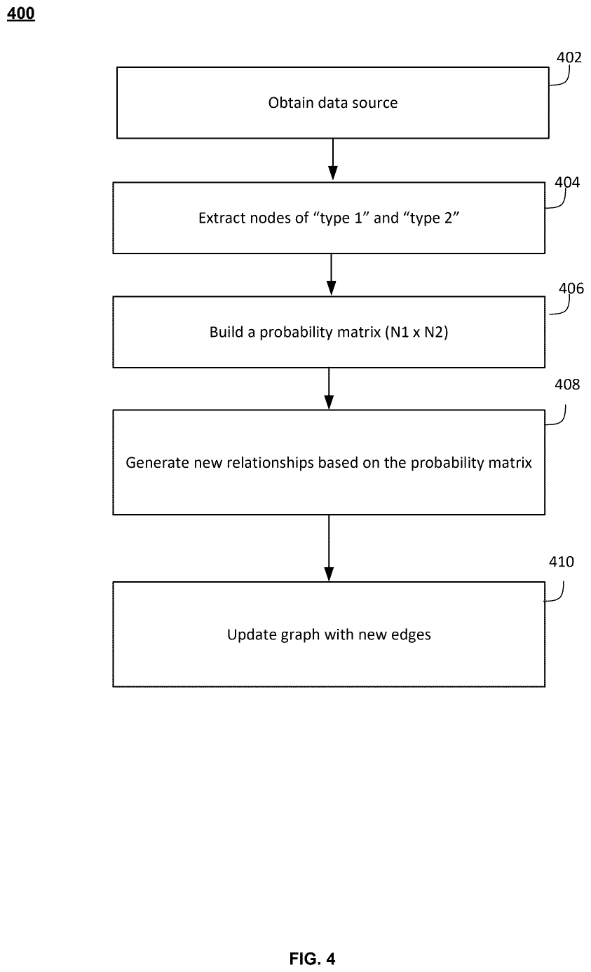

FIG. 4 is a flow diagram of a method for dynamically updating graphs with new edges in a knowledge graph according to aspects of the present disclosure. In various implementations, the method 400 is performed by a device with one or more processors and non-transitory memory that performs intent prediction. In some implementations, the method 400 is performed by processing logic, including hardware, firmware, software, or a combination thereof. In some implementations, the method 200 is performed by a processor executing code stored in a non-transitory computer-readable medium (e.g., a memory). The method 400 describes dynamically updating relationships within a LLM.

At 402, the method 400 includes obtaining data source.

At 404, the method 400 includes extracting nodes of “type_1” and “type_2”. \

At 406, the method 400 includes building a probability matrix (N1×N2). For building the probability matrix, each node may have a “text description” property that contains node entity description such as: Node.text_description. For each extracted node of “type_1” and “type_2”, generate “augmented” description summary while taking into account “new relationships” data (type, direction, and description). Next, the method 400 may include transforming “augmented” summaries into embeddings: Nodes.type_1.embeddings, Nodes.types_2.embeddings. The method 400 may also include calculating similarity_matrix=similarity(Nodes.type_1.embeddings, Nodes.type_2.embeddings) and probability_matrix=1−norm(similarity_matrix).

The optional component module 116 may be configured to extract nodes of “type_1” and “type_2” and build a probability matrix (N1*N2) of new edges existing between nodes of “type_1” and nodes of “type_2.” Based on this matrix, the optional component module 116 may generate new relationships.

At 408, the method 400 includes generating the new relationships between the graph schema of nodes and relationships between the nodes based on the probability matrix.

At 410, the method 400 includes updating graph with new edges. In some aspects, the KG updating engine 122 may update the knowledge graph database with new knowledge data and/or new relationships between the knowledge data nodes. In some aspects, the knowledge graph updating engine may also update the relationships the graph schema of nodes and relationships between the nodes without node change operations to improve graph updating operation speed.

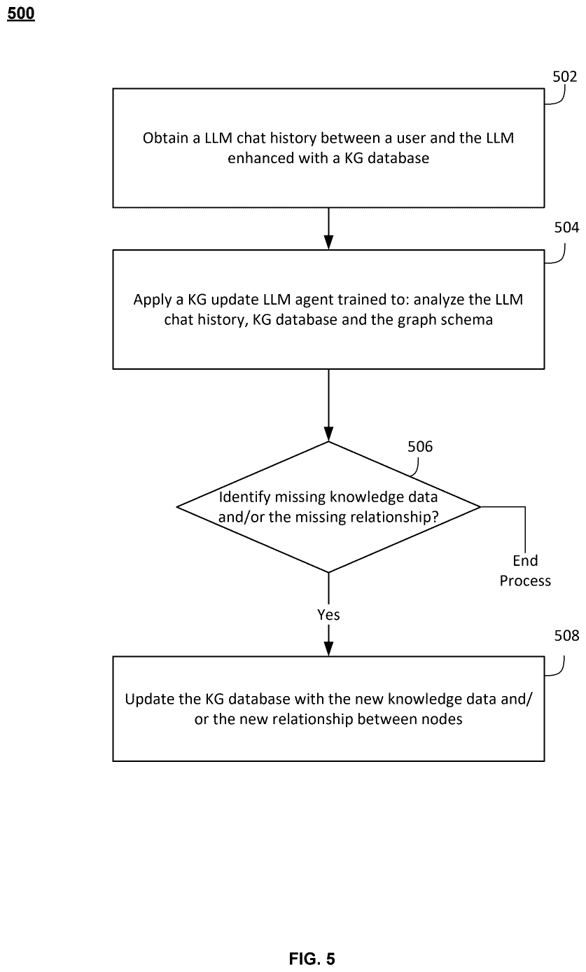

FIG. 5 is a flow diagram of a method for dynamically updating relationships within a large language model according to aspects of the present disclosure. In various implementations, the method 500 is performed by a device with one or more processors and non-transitory memory that performs intent prediction. In some implementations, the method 500 is performed by processing logic, including hardware, firmware, software, or a combination thereof. In some implementations, the method 200 is performed by a processor executing code stored in a non-transitory computer-readable medium (e.g., a memory). The method 500 describes dynamically updating relationships within a LLM.

At 502, the method 500 includes obtaining a LLM chat history between a user and the LLM enhanced with a knowledge graph database. The LLM chat history comprises a plurality of user queries, relevant knowledge data retrieved from the knowledge graph database, and LLM answers for each user query. The LLM answers are based at least in part on relevant knowledge data obtained from the dataset 126 retrieved from the knowledge graph database. The knowledge data is organized in a graph schema 124 of nodes and relationships between the nodes. As an example, referring back to FIG. 1, the collection module 112 may collect the LLM chat history 106 between the user 102 and a LLM from the LLM service provider 104 enhanced with a knowledge graph 108 database.

At 504, the method 500 includes applying a KG update MLM agent prepared to: analyze the LLM chat history, knowledge graph database and the graph schema. The LLM chat history may be analyzed to determine how satisfied a user is with the responses (e.g., answers) from the LLM. If a user does not appear to be satisfied with the response, then the graph database will be dynamically updated (e.g., changing or creating new relationships between data entities) to improve search results in a graph database. As an example, referring back to FIG. 1, the KG update MLM agent 114 may analyze the LLM chat history 106, knowledge graph 108 database and the graph schema 124.

In some aspects, the KG update MLM agent corresponds to a LLM.

In some aspects, analyzing, by the KG update MLM agent, the LLM chat history comprises analyzing feedback of the user in one or more follow-up queries to the LLM answers to identify a new knowledge data in the feedback that is missing from the knowledge graph database and/or a missing relationship between nodes in the knowledge graph database. The feedback comprises one or more of: asking the LLM a follow-up question to explain a certain topic or concept of the LLM answer, asking the LLM to include a certain new topic or a concept in LLM answer that were missing in preceding LLM answers, and asking the LLM to explain how two or more concepts or topics related to each other. As an example, referring back to FIG. 1, the KG update MLM agent 114, the optional query/feedback module 118, and the optional sentiment analysis module 120 may work individually or together to analyze feedback of the user 102 in one or more follow-up queries to the LLM answers to identify a new knowledge data in the feedback that is missing from the knowledge graph 108 database and/or a missing relationship between nodes in the knowledge graph 108 database. The feedback by the user 102 may include at least one of: asking the LLM a follow-up question to explain a certain topic or concept of the LLM answer, asking the LLM to include a certain new topic or a concept in LLM answer that were missing in preceding LLM answers, and asking the LLM to explain how two or more concepts or topics related to each other.

In some aspects, analyzing, by the KG update MLM agent, the chat history comprises: determining a level of satisfaction with the LLM answers from the user using a natural language processing (NLP)-based sentiment analysis that identifies feelings of positivity or negativity in the user queries, wherein the level of satisfaction is based on one or more of: a number of times the user repeated substantially similar query using different words; if the user indicated directly or indirectly that the LLM answer is incorrect, incomplete or unclear; if the user indicated directly or indirectly that the LLM answer is complete, correct or clear; and if the user indicated directly or indirectly that a new knowledge data made the LLM answer complete, correct or clear; and determining if a new relevant knowledge data used in the LLM answer increased the level of satisfaction with the LLM answer and whether the new relevant knowledge data has a relationship with other relevant knowledge data used in the LLM answer. In some aspects, the level of satisfaction may be quantified as a binary value (e.g., high or low) or on a scale (e.g., 1-10).

As an example, referring back to FIG. 1, the KG update MLM agent 114 and/or the optional sentiment analysis module 120 may be configured to determine a level of satisfaction with the LLM answers from the user 102 using a NLP-based sentiment analysis that identifies feelings of positivity or negativity in the user queries. The level of satisfaction by the user 102 may be based on at least one of: a number of times the user 102 repeated substantially similar query using different words; if the user 102 indicated directly or indirectly that the LLM answer is incorrect, incomplete or unclear; if the user 102 indicated directly or indirectly that the LLM answer is complete, correct or clear; and if the user 102 indicated directly or indirectly that a new knowledge data made the LLM answer complete, correct or clear; and determining if a new relevant knowledge data used in the LLM answer increased the level of satisfaction with the LLM answer and whether the new relevant knowledge data has a relationship with other relevant knowledge data used in the LLM answer.

At 506, the method 500 includes identifying: (i) a missing knowledge data from the knowledge graph database, and/or (ii) a missing relationship between the nodes in the knowledge graph database. In some aspects, identifying the missing relationships in the knowledge graph database further comprises: detecting a new type of relationships between relevant knowledge data using information from at least one of the chat history, dataset, or a graph schema. As an example, referring back to FIG. 1, the KG update MLM agent 114 may be configured to identify) a missing knowledge data from the knowledge graph 108 database, and/or a missing relationship between the nodes in the knowledge graph 108 database.

Based on a determination that there is no identified knowledge data from the knowledge graph database and/or missing relationships between the nodes in the knowledge graph database then the process ends.

Based on a determination that there is an identified missing knowledge data from the knowledge graph database, or an identified missing relationship between the nodes in the knowledge graph database, then, at 508, the method 500 includes updating the knowledge graph database with new knowledge data and/or the new relationship between the nodes. In some aspects, updating the knowledge graph database further comprises: updating the relationships the graph schema of nodes and relationships between the nodes without node change operations to improve graph updating operation speed. As an example, referring back to FIG. 1, the KG updating engine 122 may be configured to update the knowledge graph 108 database with new knowledge data and/or the new relationship between the nodes.

In some aspects, the method 500 further comprises: extracting nodes of a first type of node in the graph schema of nodes and relationships between the nodes and a second type of node in the graph schema of nodes and relationships between the nodes; building a probability matrix of new edges existing between the extracted nodes with the first type of node and the extracted nodes with the second type of node; and generating the new relationships between the graph schema of nodes and relationships between the nodes based on the probability matrix. As an example, referring back to FIG. 1, the optional component module 116 may be configured to: extracting nodes of a first type of node in the graph schema 124 of nodes and relationships between the nodes and a second type of node in the graph schema 124 of nodes and relationships between the nodes, and build a probability matrix of new edges existing between the extracted nodes with the first type of node and the extracted nodes with the second type of node. As an example, referring back to FIG. 1, the KG updating engine 122 may be configured to generate the new relationships between the graph schema of nodes and relationships between the nodes based on the probability matrix.

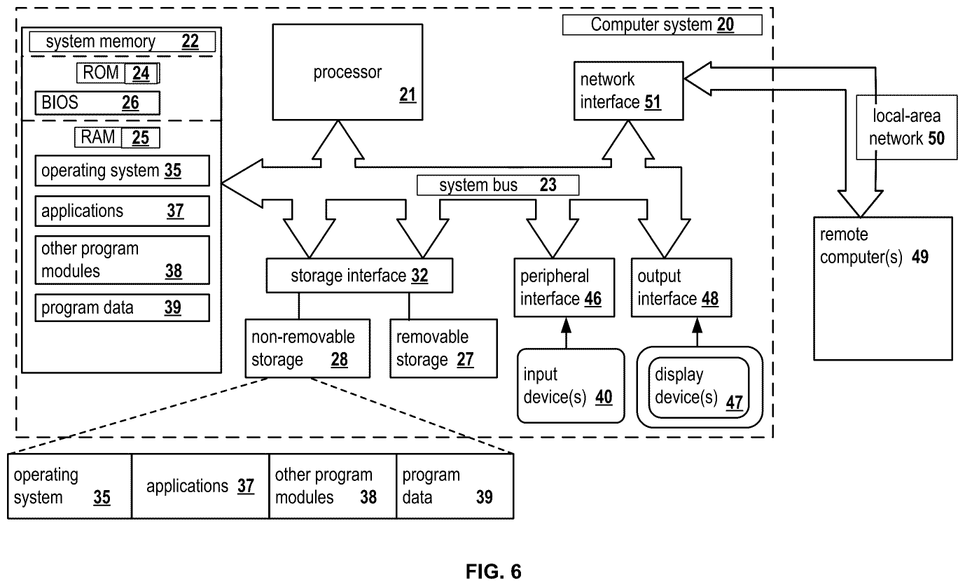

FIG. 6 is a block diagram illustrating a computer system 20 on which aspects of systems and methods for synchronizing race telemetry, video, and map data may be implemented. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I²C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-5 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

What is claimed is:

1. A method for dynamically updating relationships within a large language model (LLM), comprising:
obtaining a LLM chat history between a user and the LLM enhanced with a knowledge graph (KG) database, wherein the LLM chat history comprises a plurality of user queries, relevant knowledge data retrieved from the KG database, and LLM answers for each user query, wherein the LLM answers are based at least in part on relevant knowledge data retrieved from the KG database, wherein the knowledge data is organized in a graph schema of nodes and relationships between the nodes;
applying a KG update MLM agent prepared to: analyze the LLM chat history, KG database and the graph schema and to identify: (i) a missing knowledge data from the KG database, and/or (ii) a missing relationship between the nodes in the KG database; and
after identifying missing knowledge data and/or the missing relationship, updating the KG database with new knowledge data and/or new relationship between the nodes.

2. The method of claim 1, wherein analyzing, by the KG update MLM agent, the LLM chat history comprises:
analyzing feedback of the user in one or more follow-up queries to the LLM answers to identify a new knowledge data in the feedback that is missing from the KG database and/or a missing relationship between nodes in the KG database, wherein the feedback comprises one or more of: asking the LLM a follow-up question to explain a certain topic or concept of the LLM answer, asking the LLM to include a certain new topic or a concept in LLM answer that were missing in preceding LLM answers, and asking the LLM to explain how two or more concepts or topics related to each other.

3. The method of claim 1, wherein analyzing, by the KG update MLM agent, the chat history comprises:
determining a level of satisfaction with the LLM answers from the user using a natural language processing (NLP)-based sentiment analysis that identifies feelings of positivity or negativity in the user queries, wherein the level of satisfaction is based on one or more of: a number of times the user repeated substantially similar query using different words; if the user indicated directly or indirectly that the LLM answer is incorrect, incomplete or unclear; if the user indicated directly or indirectly that the LLM answer is complete, correct or clear; and if the user indicated directly or indirectly that a new knowledge data made the LLM answer complete, correct or clear; and
determining if a new relevant knowledge data used in the LLM answer increased the level of satisfaction with the LLM answer and whether the new relevant knowledge data has a relationship with other relevant knowledge data used in the LLM answer.

4. The method of claim 1, wherein identifying the missing relationships in the KG database further comprises:
detecting a new type of relationships between relevant knowledge data using information from at least one of the chat history, dataset, or a graph schema.

5. The method of claim 2, wherein updating the KG database further comprises:
updating the relationships the graph schema of nodes and relationships between the nodes without node change operations to improve graph updating operation speed.

6. The method of claim 1, further comprising:
extracting nodes of a first type of node in the graph schema of nodes and relationships between the nodes and a second type of node in the graph schema of nodes and relationships between the nodes;
building a probability matrix of new edges existing between the extracted nodes with the first type of node and the extracted nodes with the second type of node; and
generating the new relationships between the graph schema of nodes and relationships between the nodes based on the probability matrix.

7. The method of claim 1, wherein the KG update MLM agent corresponds to a LLM.

8. A system for dynamically updating relationships within a LLM, comprising:
at least one memory; and
at least one hardware processor coupled with the at least one memory and configured, individually or in combination, to:
obtain a LLM chat history between a user and the LLM enhanced with a knowledge graph (KG) database, wherein the LLM chat history comprises a plurality of user queries, relevant knowledge data retrieved from the KG database, and LLM answers for each user query, wherein the LLM answers are based at least in part on relevant knowledge data retrieved from the KG database, wherein the knowledge data is organized in a graph schema of nodes and relationships between the nodes;
apply a KG update MLM agent prepared to: analyze the LLM chat history, KG database and the graph schema and to identify: (i) a missing knowledge data from the KG database, and/or (ii) a missing relationship between the nodes in the KG database; and
after identifying missing knowledge data and/or the missing relationship, update the KG database with new knowledge data and/or new relationship between the nodes.

9. The system of claim 8, wherein analyzing, by the KG update MLM agent, the LLM chat history comprises:
analyzing feedback of the user in one or more follow-up queries to the LLM answers to identify a new knowledge data in the feedback that is missing from the KG database and/or a missing relationship between nodes in the KG database, wherein the feedback comprises one or more of: asking the LLM a follow-up question to explain a certain topic or concept of the LLM answer, asking the LLM to include a certain new topic or a concept in LLM answer that were missing in preceding LLM answers, and asking the LLM to explain how two or more concepts or topics related to each other.

10. The system of claim 8, wherein analyzing, by the KG update MLM agent, the chat history includes:
determining a level of satisfaction with the LLM answers from the user using a natural language processing (NLP)-based sentiment analysis that identifies feelings of positivity or negativity in the user queries, wherein the level of satisfaction is based on one or more of: a number of times the user repeated substantially similar query using different words; if the user indicated directly or indirectly that the LLM answer is incorrect, incomplete or unclear; if the user indicated directly or indirectly that the LLM answer is complete, correct or clear; and if the user indicated directly or indirectly that a new knowledge data made the LLM answer complete, correct or clear; and
determining if a new relevant knowledge data used in the LLM answer increased the level of satisfaction with the LLM answer and whether the new relevant knowledge data has a relationship with other relevant knowledge data used in the LLM answer.

11. The system of claim 8, wherein identifying the missing relationships in the KG database further comprises:
detecting a new type of relationships between relevant knowledge data using information from at least one of the chat history, dataset, or a graph schema.

12. The system of claim 9, wherein updating the KG database further comprises:
updating the relationships the graph schema of nodes and relationships between the nodes without node change operations to improve graph updating operation speed.

13. The system of claim 8, wherein the at least one hardware processor coupled with the at least one memory and is further configured, individually or in combination, to:
extract nodes of a first type of node in the graph schema of nodes and relationships between the nodes and a second type of node in the graph schema of nodes and relationships between the nodes;
build a probability matrix of new edges existing between the extracted nodes with the first type of node and the extracted nodes with the second type of node; and
generate the new relationships between the graph schema of nodes and relationships between the nodes based on the probability matrix.

14. The system of claim 8, wherein the KG update MLM agent corresponds to a LLM.

15. A non-transitory computer readable medium storing thereon computer executable instructions for dynamically updating relationships within a LLM, including instructions for:
obtaining a LLM chat history between a user and the LLM enhanced with a knowledge graph (KG) database, wherein the LLM chat history comprises a plurality of user queries, relevant knowledge data retrieved from the KG database, and LLM answers for each user query, wherein the LLM answers are based at least in part on relevant knowledge data retrieved from the KG database, wherein the knowledge data is organized in a graph schema of nodes and relationships between the nodes;
applying a KG update MLM agent prepared to: analyze the LLM chat history, KG database and the graph schema and to identify: (i) a missing knowledge data from the KG database, and/or (ii) a missing relationship between the nodes in the KG database; and
after identifying missing knowledge data and/or the missing relationship, updating the KG database with new knowledge data and/or new relationship between the nodes.

16. The non-transitory computer readable medium of claim 15, wherein analyzing, by the KG update LLM agent, the LLM chat history comprises:
analyzing feedback of the user in one or more follow-up queries to the LLM answers to identify a new knowledge data in the feedback that is missing from the KG database and/or a missing relationship between nodes in the KG database, wherein the feedback comprises one or more of: asking the LLM a follow-up question to explain a certain topic or concept of the LLM answer, asking the LLM to include a certain new topic or a concept in LLM answer that were missing in preceding LLM answers, and asking the LLM to explain how two or more concepts or topics related to each other.

17. The non-transitory computer readable medium of claim 15, wherein analyzing, by the KG update LLM agent, the chat history includes:
determining a level of satisfaction with the LLM answers from the user using a natural language processing (NLP)-based sentiment analysis that identifies feelings of positivity or negativity in the user queries, wherein the level of satisfaction is based on one or more of: a number of times the user repeated substantially similar query using different words; if the user indicated directly or indirectly that the LLM answer is incorrect, incomplete or unclear; if the user indicated directly or indirectly that the LLM answer is complete, correct or clear; and if the user indicated directly or indirectly that a new knowledge data made the LLM answer complete, correct or clear; and
determining if a new relevant knowledge data used in the LLM answer increased the level of satisfaction with the LLM answer and whether the new relevant knowledge data has a relationship with other relevant knowledge data used in the LLM answer.

18. The non-transitory computer readable medium of claim 15, wherein identifying the missing relationships in the KG database further comprises:
detecting a new type of relationships between relevant knowledge data using information from at least one of the chat history, dataset, or a graph schema.

19. The non-transitory computer readable medium of claim 16, wherein updating the KG database further comprises:
updating the relationships the graph schema of nodes and relationships between the nodes without node change operations to improve graph updating operation speed.

20. The non-transitory computer readable medium of claim 15, wherein the computer executable instructions for dynamically updating relationships within a LLM, further includes instructions for:
extracting nodes of a first type of node in the graph schema of nodes and relationships between the nodes and a second type of node in the graph schema of nodes and relationships between the nodes;
building a probability matrix of new edges existing between the extracted nodes with the first type of node and the extracted nodes with the second type of node; and
generating the new relationships between the graph schema of nodes and relationships between the nodes based on the probability matrix.
